(19) United States
(12) Patent Application Publication
(10) Pub. No.: US 2010/0303696 A1
(43) Pub. Date: Dec. 2, 2010

(54) METHOD OF TREATING A GAS STREAM

(76) Inventors: James Robert Smith, Somerset (GB); Gareth David Stanton, Avon (GB)

Correspondence Address: Edwards Vacuum, Inc., 2041 MISSION COLLEGE BOULEVARD, SUITE 260, SANTA CLARA, CA, 95054, US

(21) Appl. No.: 12/808,466

(22) PCT Filed: Dec. 2, 2008
(86) PCT No.: PCT/GB08/51142

§ 371 Date: Jun. 30, 2010

(30) Foreign Application Priority Data
Dec. 19, 2007 (GB) 0724717.4

(51) Int. Cl. B01D 53/86; B01D 53/46; B01D 53/72; B01D 53/62; B01D 53/58

(52) U.S. Cl. 423/237; 423/210; 423/245.1; 423/246; 423/248; 423/245.3; 423/247

(57) ABSTRACT

A method is described for treating a gas stream containing either fuel only or both fuel and oxidant gases, such as hydrogen, nitrous oxide or a hydrocarbon gas. The gas stream is conveyed through a vacuum pumping arrangement comprising a plurality of pumping stages. Either immediately before or immediately after the final pumping stage, the steps of adding a gaseous oxidant to the gas stream and oxidising the fuel gas are performed. By treating the gas stream in this manner, the risk of uncontrolled combustion of the fuel gas can be minimised.

The present invention relates to a method of, and apparatus for, treating a gas stream.

Many semiconductor manufacturing processes use or generate flammable gases. For example, epitaxial deposition processes conducted within a processing chamber may utilize a silicon source gas, typically silane or one of the chlorosilane compounds, in a hydrogen atmosphere at high temperature, typically around 800-1100° C., and under a vacuum condition. Other examples of gases supplied to the process chamber to form a thin film include, but are not restricted to:
Silane and ammonia for the formation of a silicon nitride film;
Silane, ammonia and nitrous oxide for the formation of a SiON film;
TEOS and one of oxygen and ozone for the formation of a silicon oxide film;

As a further example, a fuel gas may be added to a gas mixture used to etch a dielectric film.

A process tool normally has a plurality of process chambers, each of which may be at respective different stage in a deposition, etching or cleaning process. The composition of the gas stream exhausted from a process chamber typically includes a residual amount of the gas supplied to the process chamber, together with by-products from the process. Therefore, during processing a waste stream formed from a combination of the gases exhausted from the chambers may have various different compositions.

The exhaust system for drawing the exhaust gases from the process chambers typically comprises a plurality of secondary pumps, each for drawing gas from a respective process chamber, and at least one primary pump backing the secondary pumps. Consequently, the exhaust gas streams drawn from the process chambers tend to be combined within a manifold or other connected piping within the exhaust system, bringing together the process gases and by-products from a number of different processes. This can cause fuel gases from one process to be combined with oxidants from another within the piping of the exhaust system. If the exhaust gas is above its lower explosion limit (LEL), any ignition sources within the exhaust system could result in the generation of hazardous flame fronts travelling through the exhaust system.

Ignition sources may be generated by the vacuum pumps of the exhaust system. A vacuum pumping mechanism generally comprises a metallic rotor cooperating with a metallic stator to convey gas from an inlet to an outlet thereof. These components are required to have close tolerances so that the gas being pumped is prevented from leaking back towards the inlet of the pump. However, it is the close proximity of these two components which can lead to the generation of an ignition source; deformation of the components (through corrosion) and the accumulation of deposits within the running clearances can increase the likelihood of the components clashing and generating a spark.

A common technique used to avoid ignition of a flammable gas stream is to introduce into the gas stream an excess of an inert purge gas, usually nitrogen. Vacuum pumps used in the exhaust systems connected to semiconductor processing chambers have historically been either oil filled pumps or multi-stage dry pumps. However, these pumps have a limited capability to take additional purge gas into their final stages to facilitate dilution of the gas stream to a level below which an addition of an oxidising gas to a fuel gas would be unable to raise the gas stream above its lower explosion limit (LEL).

The present invention provides a method of treating a gas stream containing a fuel gas, the method comprising the steps of:
conveying the gas stream through a vacuum pumping arrangement comprising a plurality of pumping stages; and
either immediately before or immediately after the final pumping stage, adding a gaseous oxidant to the gas stream and oxidising the fuel gas.

The reactivity of gases within a gas stream is affected by the pressure of the gas stream. At pressures significantly below atmospheric pressure, for example around 100 mbar, the fuel gas and oxidant components of a flammable gas mixture become effectively inert due to rapid quenching. Therefore, the steps of adding a gaseous oxidant to the gas stream and oxidising the fuel gas are deliberately performed either immediately before the final pumping stage (that is, when the pressure of the gas stream is likely to be in the range from 20 to 900 mbar), or immediately after the final pumping stage (that is, when the pressure of the gas stream is likely to be in the range from 900 to 1200 mbar). By performing these steps in close proximity to the final pumping stage, the risk of uncontrolled combustion of the fuel gas can be minimised

An oxidation device may be used for oxidising the fuel gas. This gas may be, for example, a hydrocarbon, such as C₂H₂, C₂H₄, C₁₀H₁₆ or C₃H₆, or a non hydrocarbon, such as TEOS, CO, H₂ or NH₃. The oxidation device may comprise a suitable oxidation catalyst, such as Hopcalite from Molecular Products, which may be at least initially heated to inhibit the condensation of water within the oxidation device. As heat will be generated within the device during the oxidation of the flammable gases within the gas stream, the degree of external heating of the device may be gradually reduced or eliminated during treatment of the gas stream. The oxidation device may alternatively comprise a heated high surface area material, or other heated device suitable for performing oxidation.

As an alternative to, or in addition to, the oxidation devices above, a plasma abatement device, combustion apparatus, a gas reactor column, pyrolysis device or any other gas treatment device may be provided for oxidising the fuel gas. One preferred example of a device for oxidising the fuel gas is a pilot burner, which may be either a radiant burner or an open flame burner. An example of a pyrolysis device may comprise a suitable pyrolysis catalyst, such as a magnesium based spinel compound, through which the gas stream is passed before the addition of the gaseous oxidant to the oxidation device.

The addition of a stream of air into the gas stream can introduce ample gaseous oxidant into the gas stream for reaction with the fuel gas or pyrolysis products. This gaseous oxidant may be supplied directly to the oxidation and/or the gas treatment device, or it may be supplied to the gas stream upstream from this device or, in the case of a pyrolysis device, the gaseous oxidant may be supplied downstream of the pyrolysis device within the oxidation device.

Preferred features of the present invention will now be described, by way of example only, with reference to the accompanying drawings, in which:

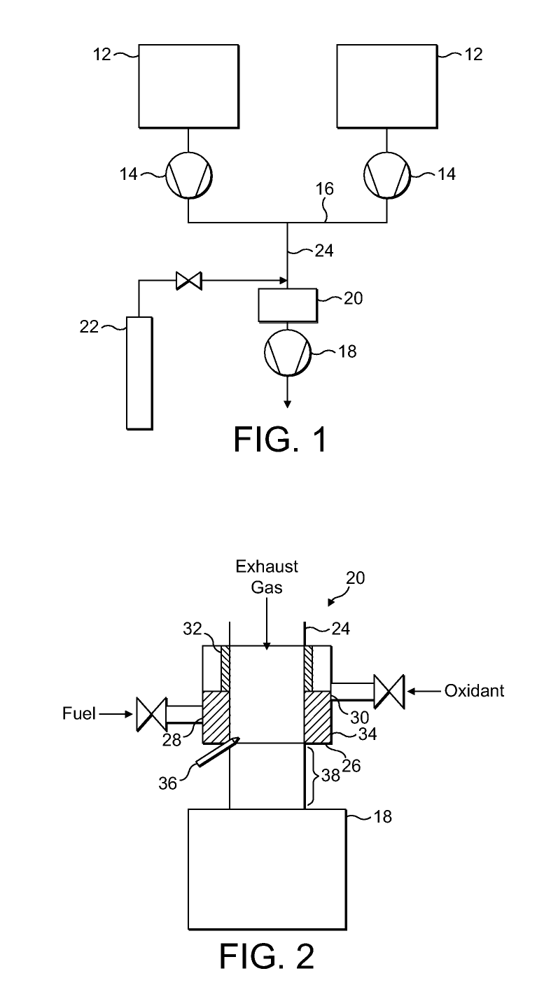

FIG. 1 illustrates an embodiment of apparatus for treating a gas stream from a plurality of process chambers;

FIG. 2 illustrates the apparatus of FIG. 1 in more detail;

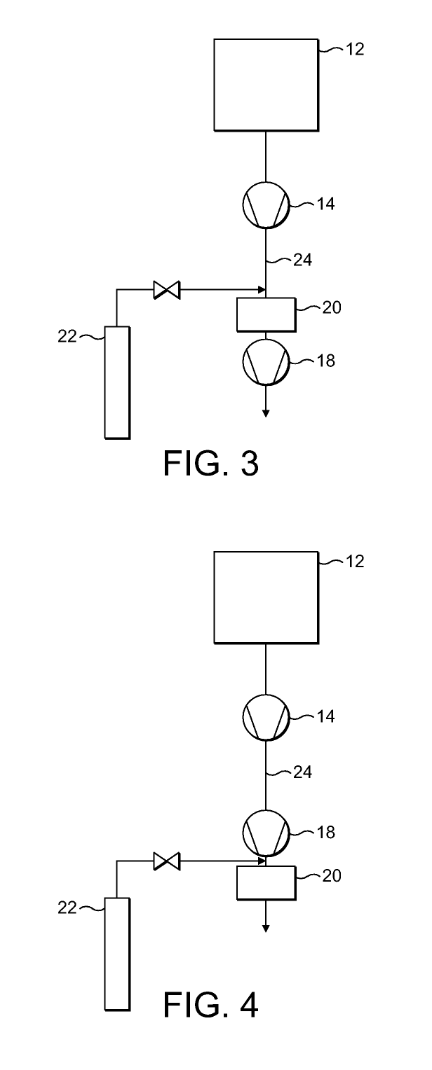

FIG. 3 illustrates the apparatus of FIG. 1 located within apparatus for drawing gas streams from a single chamber; and

FIG. 4 illustrates an alternative location for the apparatus of FIG. 1 within apparatus for drawing a gas stream from a chamber.

FIG. 1 illustrates apparatus for drawing gas from a plurality of process chambers 12 of a process tool. For simplicity only, two process chambers 12 are illustrated in the drawing. During use, process gases are supplied to the process chambers for the processing of substrates located within the chambers 12, or for chamber cleaning between processing steps. These processes may include deposition and etching processes conducted on the substrates, for example during the formation of semiconductor, flat panel display or solar devices.

In this embodiment, the apparatus for drawing gas from the process chambers 12 comprises a plurality of secondary pumps 14, each for drawing gas from a respective process chamber 12. These secondary pumps 14 may be multi-stage vacuum pumps, and examples include multi-stage turbomolecular pumps and multi-stage dry vacuum pumps having intermeshing rotors.

The gas streams exhausted from the secondary vacuum pumps 14 are combined at manifold 16, and conveyed towards primary pump 18 providing the final pumping stage of the pumping arrangement. The primary pump 18 may comprise a liquid ring pump or other single stage vacuum pump.

As dissimilar processes or cleaning processes may be conducted within the chambers 12 at any given time, the exhaust gases drawn from the chambers 12 by secondary vacuum pumps 14 may have varying components, made up from unconsumed process and cleaning gases, and by-products from reactions occurring within the chambers 12. These exhaust gases may comprise one or more fuel gases and one or more oxidants, for example, a hydrocarbon such as C₂H₂, C₂H₄, or C₃H₆, TEOS, CH₃F, CO, H₂, or NH₃ and oxidants including F₂, O₂, N₂O and NF₃; supplied to the chambers 12 as process gases themselves or as carrier gases for other process gases. To inhibit uncontrolled ignition of the fuel gas within the exhaust gases, a device 20 is provided for oxidising the fuel gas. As a flammable gas mixture tends to be effectively inert at pressures beneath 100 mbar, oxidation of the fuel gas is performed either immediately before the final pumping stage (that is, when the pressure of the gas stream is likely to be in the range from 20 to 900 mbar), or immediately after the final pumping stage (that is, when the pressure of the gas stream is likely to be in the range from 900 to 1200 mbar). By performing these steps in close proximity to the final pumping stage, the risk of uncontrolled combustion of the fuel gas can be minimised. In the example illustrated in FIG. 1, the device 20 is located immediately before the primary pump 18, which in this example is a single stage vacuum pump.

A source 22 of a gaseous oxidant is connected to the conduit 24 extending between the manifold 16 and the primary pump 18 for adding oxidant to the gas stream. The source 22 may conveniently comprise a source of air, containing oxygen as the gaseous oxidant. The gaseous oxidant may be supplied into the conduit 24 upstream from the device 20, or supplied directly to the device 20. In the case of a pyrolysis device, the gaseous oxidant may be supplied downstream of the pyrolysis device within the oxidation device 20.

FIG. 2 illustrates in more detail an example of a suitable device 20 for oxidising the fuel gas contained within the exhaust gases passing through the conduit 24. As illustrated, the device 20 may form part of, and extend about, the conduit 24 so that the exhaust gases from the process chambers 12 pass through the device 20. In this example the device 20 is in the form of a pilot burner. The device 20 comprises a housing 26 having a first gas inlet 28 for receiving a burner fuel gas, such as methane or propane, and a second gas inlet 30 for receiving the gaseous oxidant from the source 22. The pressure drop between the gas present in the conduit 24 and the pressure of the burner fuel gas and oxidant can serve to draw these gases into the device 20, with the illustrated valves serving to isolate the device 20 in the event of a pump failure.

The housing 26 contains an annular porous membrane 32 and a radiant burner 34, each extending about a flow path along which the exhaust gas passes through the device 20. The radiant burner 34 may be formed from sintered metal or ceramic dosed with metal salts. A portion of the oxidant entering the housing 26 passes through the annular porous membrane 32 into the exhaust gas so that the exhaust gas contains a sufficient amount of oxidant for reaction with the fuel gas contained in the exhaust gas. The remainder of the oxidant mixes with the burner fuel gas entering the housing 26 through the first gas inlet 28 to form a mixture of burner fuel gas and oxidant for the annular radiant burner 34. An igniting pilot burner 36 is provided for igniting the radiant burner. The pilot burner 36 may be of a conventional type having a sparking plug for igniting the mixture of burner fuel gas and oxidant supplied to the radiant burner 34. The pilot burner 36 is provided solely for the purpose of igniting this gas mixture, and so may be extinguished once ignition has take place. Once ignited, the mixture of burner fuel gas and oxidant will burn without visible flame at the radially innermost, or “exit”, surface of the radiant burner 34, and provide a controlled ignition source for the oxidation of the fuel gas contained within the exhaust gases from the chambers. The portion 38 of the conduit 24 extending immediately downstream from the device 20 provides a reaction zone within which the reaction of this fuel gas with the gaseous oxidant can be substantially completed before the exhaust gas enters the primary pump 18.

As illustrated in FIG. 3, the device 20 may be used to treat the exhaust gas from a single process chamber. FIG. 4 illustrates an alternative arrangement in which the device 20 is located immediately downstream from the primary pump 18.

1. A method of treating a gas stream containing a fuel gas, the method comprising the steps of:
conveying the gas stream through a vacuum pumping arrangement comprising a plurality of pumping stages; and
either immediately before or immediately after the final pumping stage, adding a gaseous oxidant to the gas stream and oxidising the fuel gas.

2. A method according to claim 1, wherein the vacuum pumping arrangement comprises a secondary vacuum pump comprising at least one pumping stage, and a primary vacuum pump located downstream from a secondary vacuum pump and comprising the final pumping stage, wherein the oxidant is added to the gas stream and the fuel gas is oxidised immediately upstream from the primary pump.

3. A method according to claim 2, wherein the oxidant is added to the gas stream and the fuel gas is oxidised when the gas stream is at a pressure in the range from 20 to 900 mbar.

4. A method according to claim 1, wherein the vacuum pumping arrangement comprises a vacuum pump comprising a plurality of pumping stages, said plurality of pumping stages including said final pumping stage, and wherein the oxidant is added to the gas stream and the fuel gas is oxidised immediately downstream from the vacuum pump.

5. A method according to claim 2, wherein the oxidant is added to the gas stream and the fuel gas is oxidised when the gas stream is at a pressure in the range from 900 to 1200 mbar.

6. A method according to any preceding claim, wherein the fuel gas comprises one of a hydrocarbon, SiH₄, CO, H₂, NH₃ and tetraethylorthosilicate.

7. A method according to claim 6, wherein the hydrocarbon comprises one of C₂H₂, C₂H₄, C₁₀H₁₆ and C₃H₆.

8. A method according to any preceding claim, wherein the oxidant comprises oxygen.

9. A method according to claim 8, wherein the oxidant is supplied to the gas stream within a stream of air.

10. A method according to any preceding claim, wherein the fuel gas is oxidised using a pilot burner.

11. A method according to any of claims 1 to 9, wherein the fuel gas is oxidised using an oxidation catalyst.

12. A method according to any of claims 1 to 9, wherein the fuel gas is oxidised in a heated device.

13. A method according to any of claims 1 to 9, wherein the fuel gas is oxidised in a plasma abatement device.

14. A method according to any of claims 1 to 9, wherein the fuel gas is oxidised in a device comprising a pyrolysis device.
